(19) United States
(12) Patent Application Publication
(10) Pub. No.: US 2003/0003894 A1
(43) Pub. Date: Jan. 2, 2003

(54) Developing mobile unit based estimates of metered packet charges

(76) Inventor: Anil K. Kumar, Chandler, AZ (US)

Correspondence Address: Timothy N. Trop, TROP, PRUNER & HU, P.C., STE 100, 8554 KATY FWY, HOUSTON, TX, 77024-1805, US

(21) Appl. No.: 09/892,680

(22) Filed: Jun. 27, 2001

(51) Int. Cl. H04Q 7/20

(52) U.S. Cl. 455/406; 455/408; 455/432

(57) ABSTRACT

A mobile unit-based system enables real time estimates of charges for both roaming and non-roaming services and for mobile originated and mobile terminated calls in some embodiments. In addition, each of a plurality of contexts or sessions may be separately estimated based on quality of service parameters associated with those sessions. Moreover, mobility management state information may be utilized to estimate the real time charges per session incurred during roaming and non-roaming situations in some embodiments.

### BACKGROUND

This invention relates generally to wireless telecommunication systems and particularly to such systems that provide a variety of different services.

Third generation wireless systems are packet based multi-service networks supporting a range of communication requirements for different applications. To support the multi-service features, third generation networks may guarantee a certain quality of service to each session established by a mobile subscriber. A mobile subscriber may establish up to sixteen sessions through a given packet data protocol address. A packet data protocol is any protocol that transmits data as discrete units known as packets. A packet is an information unit identified by a label.

Advice of Charge is a supplementary service that provides third generation mobile subscribers with information to produce an estimate of the cost of service used. See “Advice of Charge Supplementary Service Stage One,” 3G TS 22.086 v3.1.0 (1999-10) available from the Third Generation Partnership Project, 650 Route des Lucioles-Sophia Antipolis, Valbonne-France; Description of Charge Advice Information 3G TS 22.024 v3.00.1 (1999-10) available from the Third Generation Partnership Project. Charges are indicated for a call in progress when mobile originated or for the roaming leg only when mobile terminated.

Packet based services provided by third generation networks may include streaming audio, streaming video, multimedia and data. For these kinds of services, there may be more downlink traffic than uplink traffic. The current specification for the Advice of Charge supplementary service does not provide complete charge information for the mobile terminated calls.

The service specified in the Advice of Charge supplementary service specification is service provider based. Therefore, if the service provider chooses not to support the service, a particular mobile subscriber will not be provided with the information. In addition, the Advice of Charge supplementary service does not take into account the possibility that a particular packet data protocol address may have a plurality of sessions associated with that address. Each of those sessions may be receiving a different type of data having a different quality of service specification. Thus, the estimate received through the Advice of Charge supplementary service may be inaccurate.

Thus, there is a need for a system that better advises mobile subscribers of the charges they are incurring.

### BRIEF DESCRIPTION OF THE DRAWINGS

FIG. 1 is a schematic depiction of a system in accordance with one embodiment of the present invention;

FIG. 2 is a flow chart for software in accordance with one embodiment of the present invention;

FIG. 3 is a schematic depiction of a mobile unit in accordance with one embodiment of the present invention.

### DETAILED DESCRIPTION

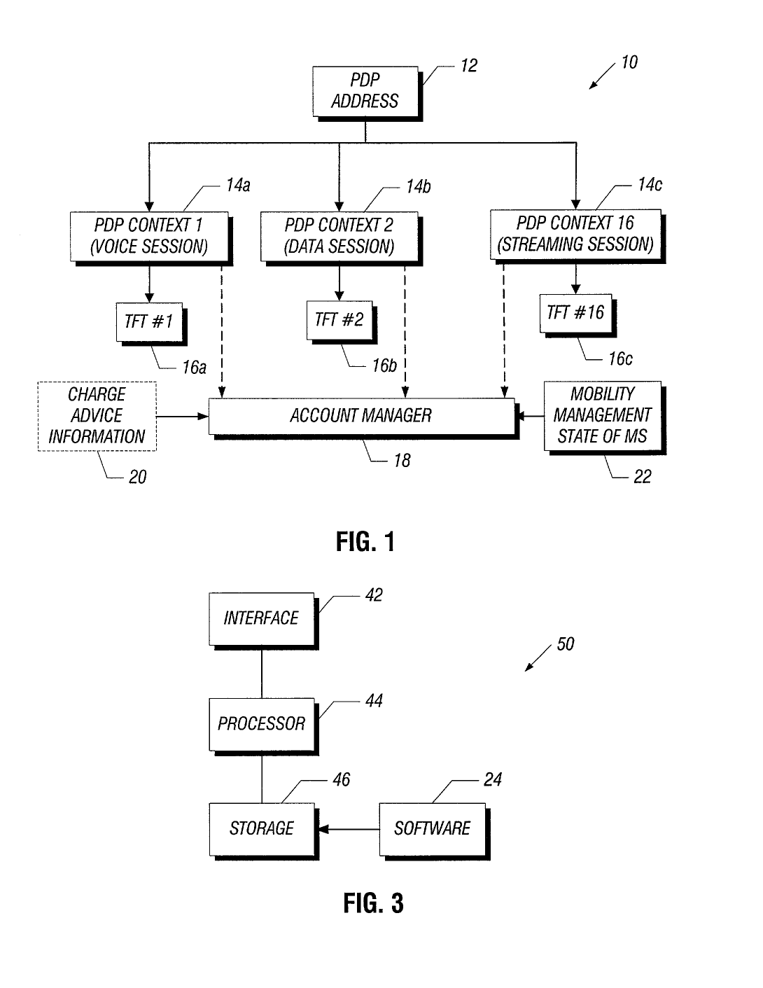

Referring to FIG. 1, a mobile unit 10 may be a cellular telephone. In one embodiment, the unit 10 is a subscriber unit in a third generation or higher mobile phone communication system.

The mobile subscriber has a packet data protocol address 12. This is the address through which the mobile subscriber is identified in the cellular network. However, in some embodiments, each mobile subscriber may have a plurality of sessions or contexts ongoing at any time. For example, sixteen sessions may be ongoing at any given time. Each of these sessions may use a different type of packet-based service.

Thus, in FIG. 1, the packet data protocol context 14a is a voice session, the context 14b is a data session, and the context 14c is a streaming session. Any of a variety of packet-based services may be established in a given session at a given packet data protocol address 12. Thus, a plurality of data sessions may be ongoing at any given time or a mixture of streaming audio, streaming video, multimedia and data services may be ongoing at any given time at a given address 12.

Each of the sessions 14 may have a specified set of quality of service parameters called a traffic flow template 16. See “General Packet Radio Service (GPRS); Service Description; Stage 2” 3G TS 22.060 v.3.2.1 (2000-01) available from The Third Generation Partnership Project. Each traffic flow template 16 provides certain quality of service parameters that may be specified for a given session. One session may have unspecified parameters and, in such case, a default may be automatically utilized in some embodiments.

Each of the sessions 14 may communicate with an account manager 18. The account manager 18, in one embodiment, may be a software module that is responsible for receiving information from the sessions 14 and determining the real time charges that have been incurred. To assist in this function, the account manager 18 may receive information from the mobility management state of the mobile unit as indicated at 22 and charge advice information pursuant to various specifications including the Advice of Charge supplementary service, as indicated at block 20. Of course, in some cases, the charge advice information 20 may be available and in other cases, a network or service provider may opt not to provide that information.

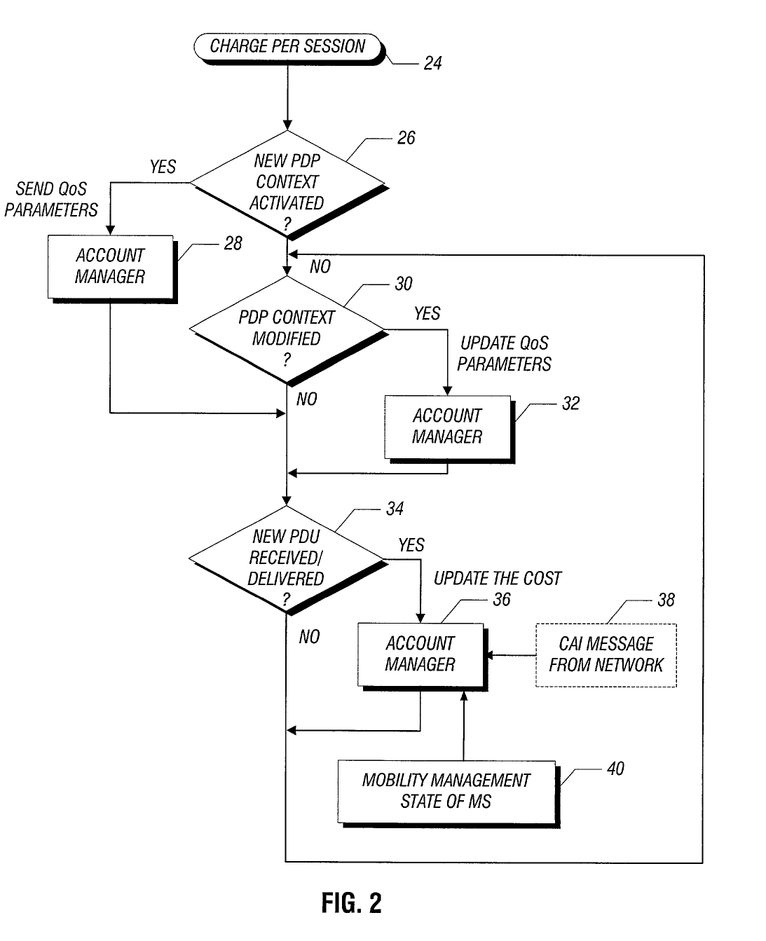

Software 24, shown in FIG. 2, may estimate the charge for each of the sessions 14. This estimate may be based on a wide variety of measures including the number of packet data units that are being transmitted across the network. In one embodiment, the packet data units may correspond to home units that are the basic telecommunication unit as published by the mobile subscriber's home public land mobile network (home PLMN) and may be in the currency of the mobile subscriber's home country. Additional information that may be utilized to assess the charges may include the number of packet data units that are received by the mobile subscriber. Also relevant may be the quality of service parameter information for each session based on the traffic flow template 16 for that session. The charge advice information message received from the network at the beginning of the call may also be useful. This message may be pursuant to the Third Generation Partnership Project technical specification 3G TS 22.024 in one embodiment.

The mobility management state information for charge estimation for all call legs including roaming and non-roaming calls may be used. Mobility management is a relation between the mobile station and the Universal Terrestrial Radio Access Network that is used to set up, maintain and release the various physical channels. See “General Packet Radio Service (GPRS); Service Description; Stage 2” 3G TS 22.060 v.3.2.1 (2000-01) available from the Third Generation Partnership Project. Thus routing area (RA) updates may be acquired upon call origination and termination. The identified routing area may be used to determine charges including roaming charges, for example using a look up table. These charges may be determined for both mobile originated and mobile terminated calls.

The Universal Terrestrial Radio Access Network identifies that part of a network that consists of radio network controllers and node b's. A node b is a logical node responsible for radio transmission or reception in one or more cells to or from user equipment. A radio network controller is equipment in charge of controlling the use and integrity of radio resources.

Thus a report may be developed of charges based on protocol data unit transmissions, providing the packet-based mobile subscriber with the capability to manage his or her account and keep track of charges incurred. In some embodiments, the charges may be specified in terms of home units and in other embodiments, the charges may be specified in the currency of the home user's country, as two examples.

Initially, the software 24 determines whether a new packet data protocol context or session has been activated as determined at diamond 26. If so, the quality of service (QoS) parameters for that session are sent to the account manager 18 as indicated in block 28.

If a new context or session is not activated, a check at diamond 30 determines whether a context or session has been modified. If so, the updated quality of service parameters are provided to the account manager 18 as indicated in block 32.

A check at diamond 34 indicates whether any new packet data units have been received or delivered. If so, the cost is updated to the account manager 18 as indicated at block 36. The account manager 18 may also receive charge advice information messages from the network as indicated at 38 in some situations. In addition, the account manager may receive the mobility management state of the mobile subscriber as indicated at 40. The flow then recycles back to diamond 30.

Referring to FIG. 3, a mobile unit 50 may include a network interface 42 coupled to a processor 44. The processor 44 may have an associated storage 46. The storage 46 may store the charge per session software 24 in one embodiment.

Embodiments of the present invention may provide charge information to mobile terminals irrespective of the applicable air interface. Moreover, in some embodiments, a real time estimate of the charges per session may be provided, irrespective of whether or not the applicable service provider supports Advice of Charge supplementary services. In addition, in some embodiments, the account manager 18 provides a real time estimate of cost per session for all legs, roaming and non-roaming. Moreover, in some embodiments, the quality of service parameters may be utilized to supplement the estimate of costs of service per session. Thus, each of a variety of sessions may have a different service, which may incur costs at a different rate.

Finally, in some embodiments, the account manager 18 may utilize mobility management state information to estimate the real time charges per session incurred during roaming and non-roaming scenarios.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
establishing a plurality of sessions at a given packet data protocol address; and
separately assessing charges for each of those sessions.

2. The method of claim 1 including estimating the charges for all legs of mobile terminated calls.

3. The method of claim 1 including providing a real time estimate of charges for each of those sessions.

4. The method of claim 1 including using information from Advice of Charge supplementary services.

5. The method of claim 1 including using quality of service parameters to supplement the estimate of costs for each session.

6. The method of claim 1 including utilizing mobility management state information to estimate real time charges per session.

7. An article comprising a medium storing instructions that enable a processor-based system to:
establish a plurality of communication sessions at a given packet data protocol address; and
separately assess charges for each of those sessions.

8. The article of claim 7 further storing instructions that enable the processor-based system to estimate the charges for all legs of mobile terminated calls.

9. The article of claim 7 further storing instructions that enable the processor-based system to provide a real time estimate of charges for each of those sessions.

10. The article of claim 7 further storing instructions that enable the processor-based system to use information from Advice of Charge supplementary services.

11. The article of claim 7 further storing instructions that enable the processor-based system to use quality of service parameters to supplement the estimate of cost for each session.

12. The article of claim 7 further storing instructions that enable the processor-based system to utilize mobility management state information to estimate real time charges per session.

13. A wireless telephone comprising:
a processor; and
a storage storing instructions that enable the processor to establish a plurality of sessions at a given packet data protocol address and separately assess charges for each of said sessions.

14. The telephone of claim 13 wherein said software stores instructions enable the processor to estimate the charges for all legs of mobile terminated calls.

15. The telephone of claim 13 wherein said software storage stores instructions that enable the processor to provide a real time estimate of the charges for each session.

16. The telephone of claim 13 wherein said storage stores instructions that enable the processor to use information from the Advice of Charge supplementary services.

17. The telephone of claim 13 wherein said storage stores instructions that enable the processor to use quality of service parameters to supplement the estimate of cost for each session.

18. The telephone of claim 13 wherein said storage stores instructions that enable the processor to utilize mobility management state information to estimate real time charges per session.

19. The telephone of claim 13 wherein said telephone receives voice, data, and streaming video.

20. The telephone of claim 13 wherein said telephone is a third generation wireless telephone.

21. A method comprising:
accessing mobility management information for call origination and call termination; and
using the mobility management information to assess a charge for a telephonic communication.

22. The method of claim 21 including using the mobility management information to determine if a telephone call is a roaming or non-roaming call.

23. The method of claim 21 including determining a charge for a non-roaming leg when a call is mobile terminated.

24. An article comprising a medium storing instructions that enable a processor-based system to:
access mobility management information for call origination and call termination; and
use the mobility management information to assess a charge for a telephonic communication.

25. The article of claim 24 further storing instructions that enable the processor-based system to use the mobility management information to determine if a telephone call is a roaming or non-roaming call.

26. The article of claim 24 further storing instructions that enable the processor-based system to determine a charge for a non-roaming leg when the call is mobile terminated.

27. A wireless telephone comprising:
a processor; and
a storage storing instructions that enable the processor to access mobility management information for both call origination and call termination and use the mobility management information to assess a charge for a telephonic communication.

28. The system of claim 27 wherein said storage stores instructions that enable the processor to use the mobility management information to determine if a telephone call is a roaming or non-roaming call.

29. The system of claim 27 wherein said storage stores instructions that enable the processor to determine a charge for a non-roaming leg when a call is mobile terminated.

30. The system of claim 27 wherein said telephone is a third generation wireless telephone.
